(19) United States
(12) Patent Application Publication
(10) Pub. No.: US 2012/0079404 A1
(43) Pub. Date: Mar. 29, 2012

(54) METHOD FOR CREATING AND SEARCHING A FOLDER IN A COMPUTER SYSTEM

(76) Inventors: Yen-Ting Chen, Taipei City (TW); Wen-Jeng Fang, Taipei City (TW); Chih-Heng Chiu, Taipei City (TW); Chung-Won Shu, Taipei City (TW)

(21) Appl. No.: 12/888,417

(22) Filed: Sep. 23, 2010

(51) Int. Cl. G06F 3/048

(52) U.S. Cl. 715/765

(57) ABSTRACT

In a computer system, a folder is created so as to include at least one non-textual image description, such as image or audio, a textual description, or any combination thereof. A target folder may also be searched according to at least one non-textual image feature, such as image or audio, a textual feature, or any combination thereof.

### BACKGROUND OF THE INVENTION

1. Field of the Invention

The present application is related to a method for creating and searching a folder in a computer system, and more particularly, to a method for creating and searching a folder in a computer system without using physical or virtual keyboards.

2. Description of the Prior Art

One significant feature of modern computer systems is the ability to provide users with easy access to information and programs available for use on the computer system. This is generally facilitated through the development of graphical user interfaces which are configured to display icons on a screen. Icons are small predefined graphical images displayed on the screen in order to represent certain objects accessible to the user, such as files of information, documents, programs, or file folders. The icon image is typically associated with the type of document or program represented by the icon.

A folder in a computer system is a virtual container within a digital file system, in which groups of computer files and other folders can be kept and organized. In order to organize hundreds of thousand of files present in the computer system, folders are used to gather related items that can be retrieved, moved, and otherwise manipulated as one entity. One common application is to create a personal photo album on personal computers. A user may create a folder named “PHOTO ALBUM”, in which many subfolders named by the destination for storing digital images taken from different locations may be stored in an organized manner.

FIG. 1 is a diagram illustrating a conventional method of creating a new folder in a computer system. The computer system is configured to operate according to commands which are entered using a mouse or a keyboard. In a conventional application, a predefined folder icon is displayed on the screen of the computer system after a user delivers the request (such as by right-clicking the mouse on the desktop followed by left-clicking the associated options). The folder icon is depicted with a highlighted name tag, whose text content “New Folder” may be replaced by an appropriate name inputted using the keyboard, such as “PHOTO ALBUM”. After the folder “PHOTO ALBUM” has been created, the user may continue to create other subfolders for containing photos taken indifferent locations in the same manner. Later, an existing folder may be searched by inputting the complete or partial text of the folder name.

Folders are typically identified with an icon image depicting a small file folder with a name tag in the computer system. The user is allowed to input the text of the name tag, usually according to the content of the folder, and make as many changes as he wants as long as all the rules are obeyed. For instance, the name of each folder in the same data hierarchy needs to be unique and certain symbols are forbidden when naming folders. The image of a yellow file folder which slightly opens (as depicted in FIG. 1) is the most commonly chosen icon for representing folders. The user may select another one of many predefined icon images for representing folders according to personal preferences. However, once the selection is made, each folder is represented by the same icon image regardless of its content. The folder icon conveys to the user the simple fact that the folder exists, and the name tag indicates what might be the content of this particular folder. In other words, each folder in the same data hierarchy is distinguishable by its name, a textual content based on which folder search is performed.

With rapid size shrinkage, many mobile devices such as Tablet PC, I-Pad or Smartphone adopt touchscreens which not only function as display screens, but also as input devices in place of traditional mouse and keyboard. A virtual keyboard, a software component that allows a user to enter characters in a computer system without physical input devices, is required for inputting text content so that each newly created folder can be appropriately named. There is need for a method of creating folders on such mobile devices without using virtual or physical keyboard.

### SUMMARY OF THE INVENTION

The present application provides a method for creating a folder in a computer system. The method includes providing a non-textual description of the folder and displaying the non-textual description on a screen of the computer system for representing the folder, wherein the folder is represented without any textual description.

The present application also provides a method for searching a target folder in a computer system. The method includes providing a non-textual feature; comparing the non-textual feature with a representative non-textual description of each existing folder in a current data hierarchy of the computer system; and displaying an existing folder having a representative non-textual description which matches the non-textual feature to a predetermined degree.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional method of creating a new folder in a computer system.

FIG. 2 is a flowchart illustrating a method for creating a new folder in a computer system according to the present application.

FIGS. 3, 4, 5 and 6A-6D are diagrams illustrating embodiments of the method in FIG. 2 for creating a new folder in a computer system.

FIG. 7 is a flowchart illustrating a method of searching a target folder in a computer system according to the present application.

FIGS. 8 and 9 are diagrams illustrating embodiments of the method in FIG. 7 for searching a target folder in a computer system.

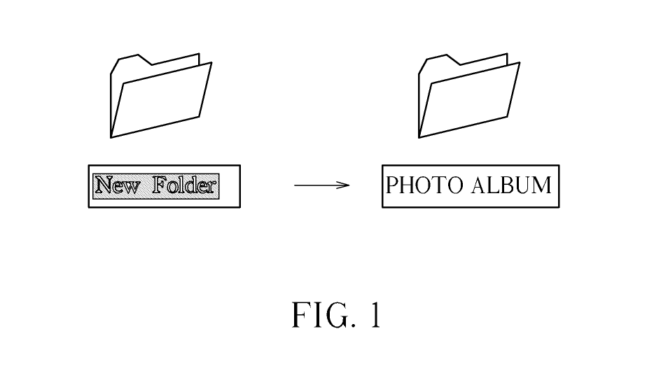

### DETAILED DESCRIPTION

In the present application, one or more non-textual features are used for representing each folder on the graphical user interface. These non-textual features may be inputted without physical or virtual keyboard.

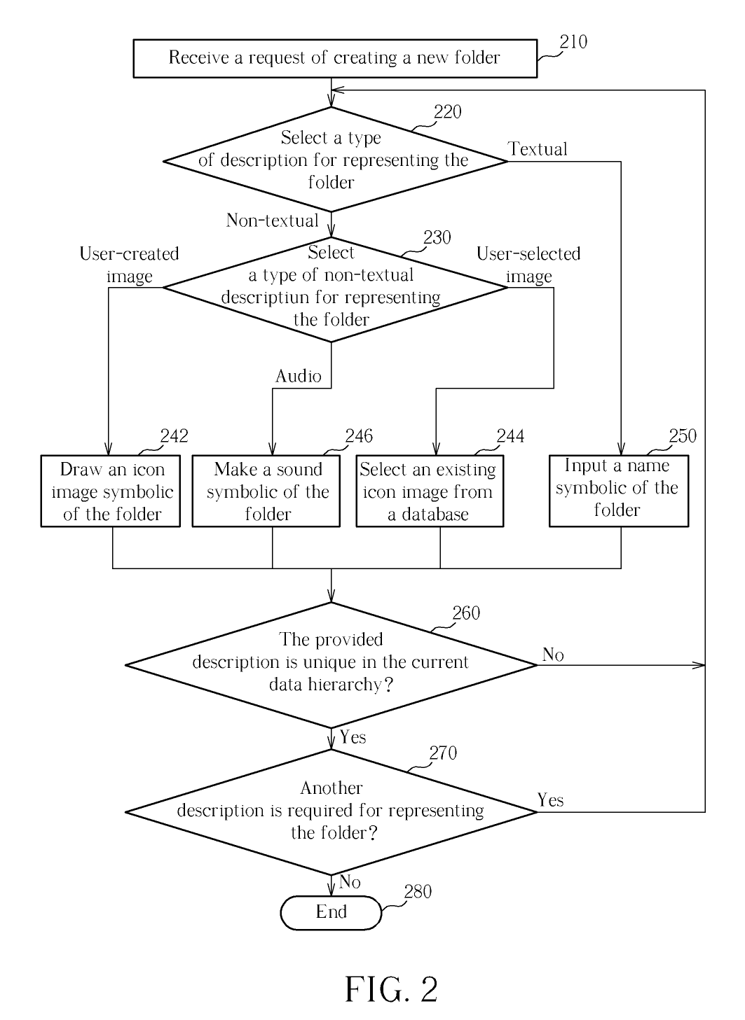

FIG. 2 is a flowchart illustrating a method for creating a new folder in a computer system according to the present application. The computer system may be any digital appliance which is configured to operate without physical input devices such as mouse or keyboard.

Step 210: Receive a request of creating a new folder.

Step 220: Select a type of description for representing the folder: if a non-textual description is selected, execute 230; if a textual description is selected, execute 250;

Step 230: Select a type of non-textual description for representing the folder: if a non-textual user-created image description is selected, execute 242; if a non-textual user-selected image description is selected, execute 244; if a non-textual audio description is selected, execute 246;

Step 242: Provide the non-textual user-created image description by drawing an icon image symbolic of the folder; execute 260.

Step 244: Provide the non-textual user-selected image description by selecting an existing icon image from a database; execute 260.

Step 246: Provide the non-textual audio description by making a sound symbolic of the folder; execute 260.

Step 250: Provide the textual description by inputting a name symbolic of the folder; execute 260.

Step 260: Verify whether the provided description is unique in the current data hierarchy: if the provided description is unique, execute step 270; if the provided description is not unique, execute step 220.

Step 270: Determine whether another description is required for representing the folder: if yes, execute step 220; if no, execute step 280.

Step 280: End.

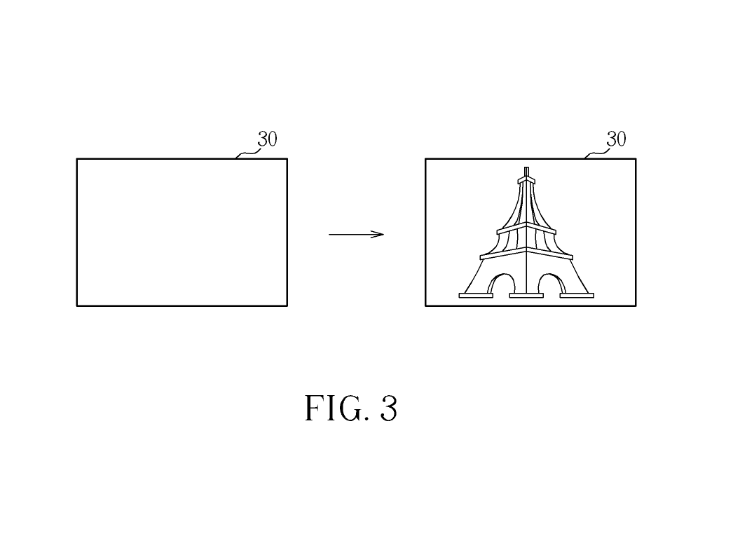

FIG. 3 is a diagram illustrating an embodiment of the method in FIG. 2 for creating a new folder in a computer system. The present method according to the embodiment depicted in FIG. 3 may be applied to a computer system which includes any digital appliance configured to operate according to tactile inputs from a finger or a stylus. After a user issues a touch command in step 210, assume that the non-textual user-created image description is selected for representing the folder in steps 220 and 230. An input region 30 is displayed on the screen of the computer system so that the user may manually draw an icon image within the input region 30 using his finger or a stylus in step 242. The folder icon image may be created in a way so as to associate with the folder content. For example, when creating a folder for containing travel photos, a landmark of the destination may be created for representing the location where the photos were taken, such as the hand-drawn sketch of the Eiffel Tower as depicted on the right side of FIG. 3. By referencing to the non-textual image features of all other existing folders in the current directory, the uniqueness of the non-textual image description created in step 242 may be verified in step 260 so that each folder in the same data hierarchy may be distinguishable by a distinct icon image.

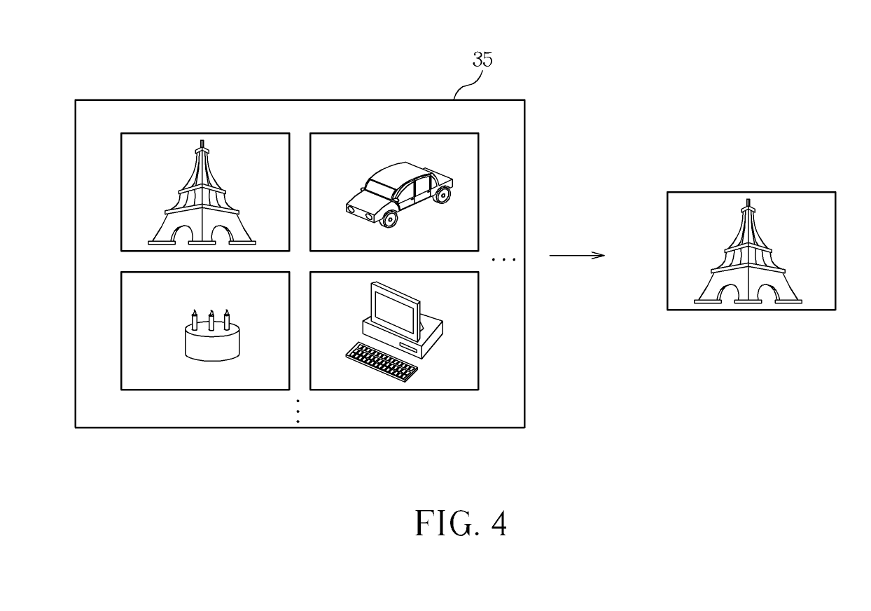

FIG. 4 is a diagram illustrating an embodiment of the method in FIG. 2 for creating a new folder in a computer system. The present method according to the embodiment depicted in FIG. 4 may be applied to a computer system which includes any digital appliance configured to operate according to tactile inputs from a finger or a stylus. After a user issues a touch command in step 210, assume that the non-textual user-selected image description is selected for representing the folder in steps 220 and 230. A selection interface 35 showing a plurality of existing icon images in the database is displayed on the screen so that the user may select an icon image using his finger or a stylus in step 244. The user may make the selection based on personal preference or in a way so as to associate with the folder content. For example, when creating a folder for containing travel photos, an existing icon image which is most closely related to the destination may be selected for representing the location where the photos were taken, such as the one depicted on the top-left corner of the selection interface 35 in FIG. 4. By referencing to the non-textual image features of all other existing folders in the current directory, the uniqueness of the non-textual image description created in step 244 may be verified in step 260 so that each folder in the same data hierarchy may be distinguishable by a distinct icon image.

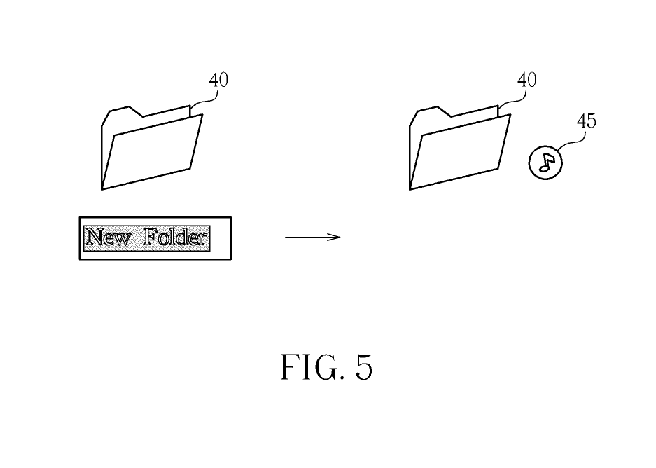

FIG. 5 is a diagram illustrating another embodiment of the method in FIG. 2 for creating a new folder in a computer system. The present method according to the embodiment depicted in FIG. 5 may be applied to a computer system which includes any digital appliance capable of recognizing and processing audio inputs. After a user issues a touch command in step 210, assume that the non-textual audio description is selected for representing the folder in steps 220 and 230. A folder icon 40 is displayed with a highlighted name tag “New Folder” on the screen of the computer system and the user may narrate the desired folder name in step 246. After processing the audio data, the folder is displayed as an icon 40 tagged with the audio message 45 containing the narration of the folder name, such as the sound of the user saying the word “photo album”. By referencing to the non-textual audio features of all other existing folders in the current directory, the uniqueness of the non-textual audio description created in step 246 may be verified in step 260 so that each folder in the same data hierarchy may be distinguishable by a distinct audio message.

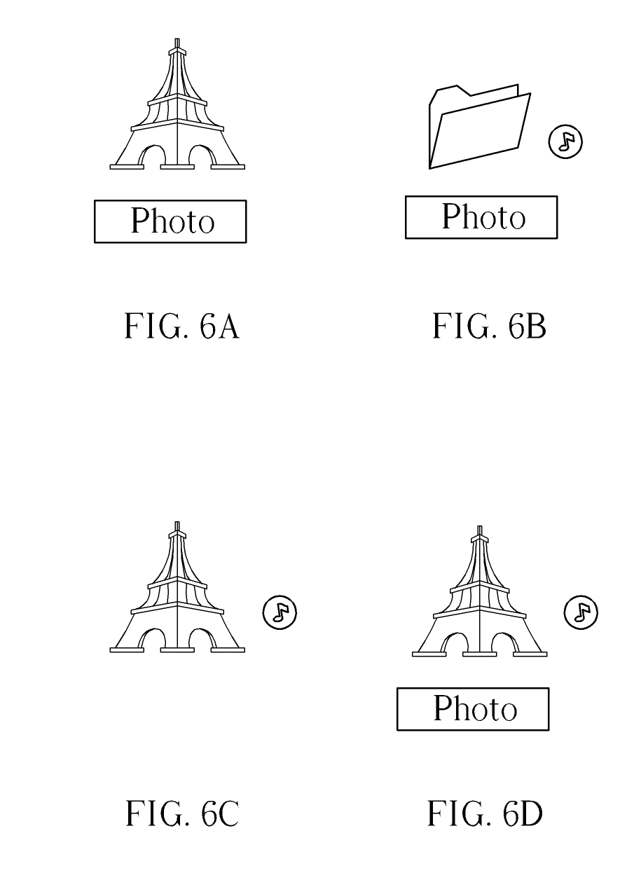

FIGS. 6A-6D are diagrams illustrating other embodiments of the method in FIG. 2 for creating a new folder with multiple descriptions in a computer system. In the embodiments illustrated in FIGS. 3-5, one non-textual description (image or audio) is used for representing the folder; in the embodiments illustrated in FIGS. 6A-6D, multiple descriptions, which may be any combination of non-textual descriptions (image or audio) and the textual description (folder name), may be used for representing the folder by making the selection in step 270 to loop back to step 220. In FIG. 6A, the folder is displayed with the textual description of folder name and the non-textual image description (user-created or user-selected); in FIG. 6B, the folder is displayed with the textual description of folder name and the non-textual audio description; in FIG. 6C, the folder is displayed with the non-textual image description (user-created or user-selected) and the non-textual audio description; in FIG. 5D, the folder is displayed with the textual feature of folder name, the non-textual image description (user-created or user-selected) and the non-textual audio description. Each type of description may be added to the folder in an arbitrary sequence according to user selection.

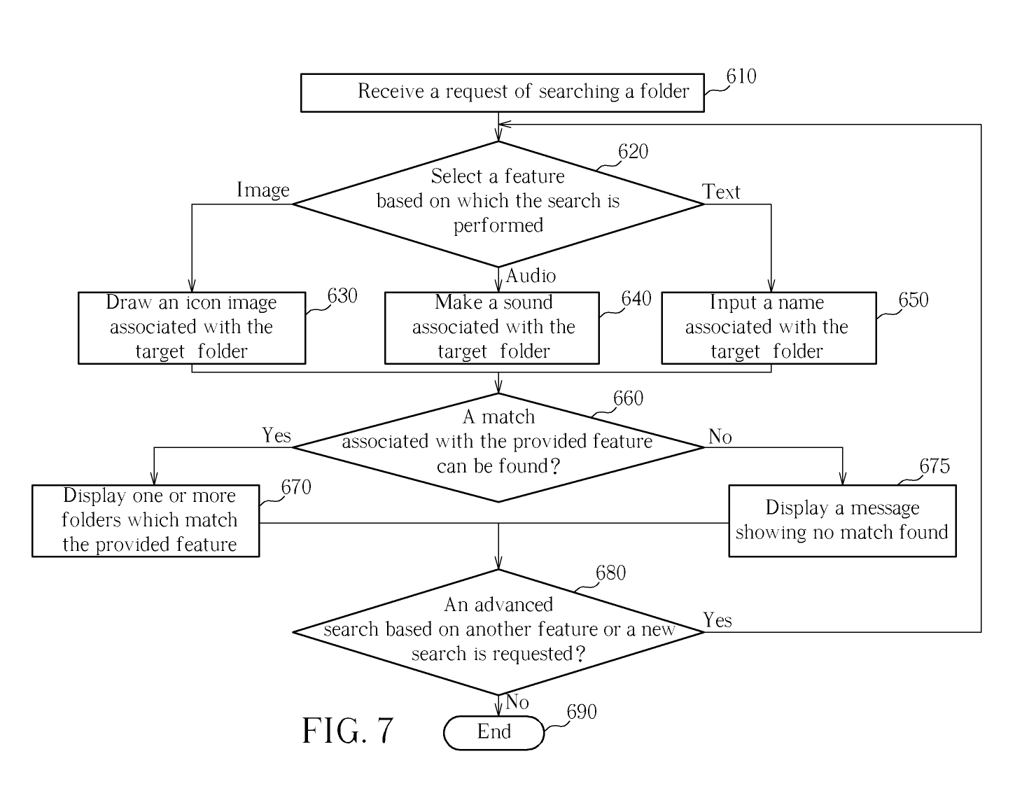

FIG. 7 is a flowchart illustrating a method of searching a target folder in a computer system according to the present application. The computer system may be any digital appliance which is configured to operate without physical input devices such as mouse or keyboard.

Step 610: Receive a request of searching a target folder.

Step 620: Select a feature based on which the search is performed: if a non-textual image feature is selected, execute 630; if a non-textual audio feature is selected, execute 640; if a textual feature is selected, execute 650.

Step 630: Provide the non-textual image feature by drawing an icon image associated with the target folder; execute 660.

Step 640: Provide the non-textual audio feature by making a sound associated with the target folder; execute 660.

Step 650: Provide the textual feature by inputting a name associated with the target folder; execute 660.

Step 660: Determine whether a match associated with the provided feature can be found: if yes, execute 670; if no, execute 675.

Step 670: Display one or more folders whose representative non-textual description matches the provided feature; execute 680.

Step 675: Display a message showing “no match found”, execute 680.

Step 680: Determine whether an advanced search based on another feature or a new search is requested: if yes, execute step 620; if no, execute step 690.

Step 690: End.

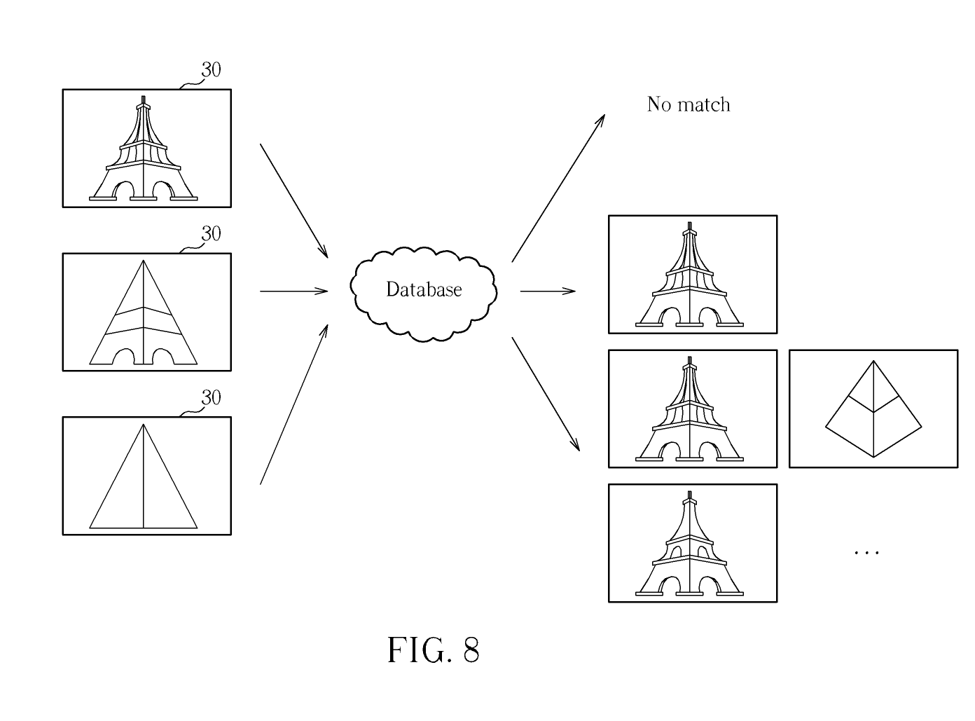

FIG. 8 is a diagram illustrating an embodiment of the method in FIG. 7 for searching a target folder in a computer system. The present method according to the embodiment depicted in FIG. 8 may be applied to a computer system which includes any digital appliance configured to operate according to tactile inputs from a finger or a stylus, and may be used for searching folders which are created according to the method illustrated in FIG. 3 or 4. After a user issues a search command in step 610, an input region 30 is displayed on the screen of the computer system if the non-textual image feature is selected in step 620. Next, the user may manually draw an icon image associated with the target folder within the input region 30 using his finger or a stylus in step 630. The computer system is configured to search in its database and display corresponding messages based on search result. When searching the target folder represented by a specific icon image, the user may provide the exact drawing of the specific icon image, a partial sketch of the specific icon image, or a simplified contour resembling the specific icon image, as depicted on the left side of FIG. 8. After comparing the non-textual image feature with the representative non-textual image description of each existing folder in its database, the computer system may display one result of a folder whose representative non-textual image description best matches the icon image provided by the user (middle right of FIG. 8), multiple results of folders whose representative non-textual image descriptions match the icon image provided by the user to a certain degree (bottom right of FIG. 8), or a message indicating no matching folder can be found (top right of FIG. 8).

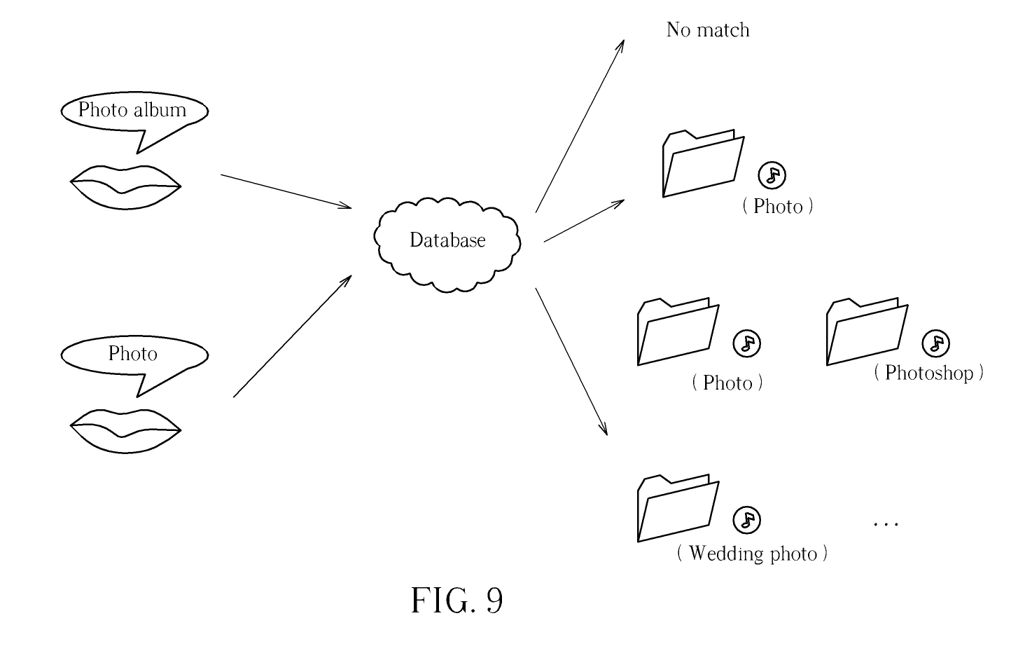

FIG. 9 is a diagram illustrating an embodiment of the method in FIG. 7 for searching a target folder in a computer system. The present method according to the embodiment depicted in FIG. 9 may be applied to a computer system which includes any digital appliance capable of recognizing and processing audio inputs, and may be used for searching folders which are created according to the method illustrated in FIG. 2. If the non-textual audio feature is selected in step 620, the user may make a sound associated with the target folder in step 640. The computer system is configured to search in its database and display corresponding messages based on search result. When searching the target folder represented by a specific audio message, the user may narrate the entire content of the specific audio message or a segment of the specific audio message, as depicted on the left side of FIG. 9. After searching in its database, the computer system may display one result of a folder whose representative non-textual audio description best matches the sound provided by the user (middle right of FIG. 9), multiple results of folders whose representative non-textual audio description match the sound provided by the user to a certain degree (bottom right of FIG. 9), or a message indicating no matching folder can be found (top right of FIG. 9). In FIG. 9, the contents of the displayed audio messages are shown in brackets for illustrative purpose.

In the embodiments illustrated in FIGS. 8 and 9, one non-textual feature is used for searching the target folder. However, an advanced search based on a second non-textual feature or a new search may be performed by looping back to step 620 after step 680 in the present application.

In the embodiments illustrated in FIGS. 2 and 7, the non-textual user-created image description for creating a new folder (step 242) and the non-textual image feature for searching a folder (step 630) may be provided by drawing an image directly on the touch screen of the computer system. However, an external device, such as a graphic tablet which allows one to hand-draw images, may be used for the same purpose.

In the conventional method of creating a new folder in a computer system, a fixed icon image and a user-imputable folder name are used for representing the new folder on the graphical user interface. The folder name is a textual description which is inputted using physical or virtual keyboard. In the present application, one or more non-textual descriptions are used for representing the new folder on the graphical user interface. Each folder is created so as to include at least one non-textual description, based on which subsequent search may also be performed. These non-textual descriptions may be inputted without physical or virtual keyboard. The present application provides a method for creating or searching a folder in a computer system which does not have input devices such as mouse or keyboard.

Those skilled in the art will readily observe that numerous modifications and alterations of the device and method may be made while retaining the teachings of the invention.

What is claimed is:

1. A method for creating a folder in a computer system, comprising:
providing a non-textual description of the folder; and
displaying the non-textual description on a screen of the computer system for representing the folder, wherein the folder is represented without any textual description.

2. The method of claim 1, wherein the step of providing a non-textual description of the folder comprising:
drawing an icon image to be shown on the screen of the computer system for representing the folder.

3. The method of claim 1, wherein the step of providing a non-textual description of the folder comprising:
selecting from a database an existing icon image to be shown on the screen of the computer system for representing the folder.

4. The method of claim 3, wherein the screen of the computer system is a touch screen.

5. The method of claim 2, wherein the screen of the computer system is a touch screen.

6. The method of claim 2 further comprising:
making a sound representing the folder.

7. The method of claim 1, wherein the step of providing a non-textual description of the folder comprising:
making a sound representing the folder.

8. The method of claim 1 further comprising:
verifying a uniqueness of the provided non-textual description in a data hierarchy of the folder before displaying the non-textual description on the screen of the computer system.

9. A method for searching a target folder in a computer system, comprising:
providing a non-textual feature;
comparing the non-textual feature with a representative non-textual description of each existing folder in a current data hierarchy of the computer system; and
displaying an existing folder having a representative non-textual description which matches the non-textual feature to a predetermined degree.

10. The method of claim 9, wherein the step of providing a non-textual feature comprising:
drawing an icon image to be shown on the screen of the computer system.

11. The method of claim 9, wherein the screen of the computer system is a touch screen.

12. The method of claim 9, wherein the step of providing a non-textual feature comprising:
making a sound associated with the target folder.
